(19) United States
(12) Patent Application Publication
(10) Pub. No.: US 2009/0285926 A1
(43) Pub. Date: Nov. 19, 2009

(54) APPARATUS FOR ENHANCING HARDNESS OF NANOIMPRINT MOLD AND METHOD THEREOF

(75) Inventors: Yeau-Ren Jeng, Tainan (TW); Chung-Ming Tan, Chiayi (TW)

Correspondence Address: WPAT, PC;INTELLECTUAL PROPERTY ATTORNEYS, 2030 MAIN STREET, SUITE 1300, IRVINE, CA, 92614, US

(73) Assignee: NATIONAL CHUNG CHENG UNIVERSITY, Chia-Yi (TW)

(21) Appl. No.: 12/431,390

(22) Filed: Apr. 28, 2009

(30) Foreign Application Priority Data
May 15, 2008 (TW) 097117920

(51) Int. Cl. B29C 33/38; B29C 43/02

(52) U.S. Cl. 425/423; 264/219; 264/405

(57) ABSTRACT

The present invention discloses a hardness enhancing apparatus for use in a nanoimprint mold, comprising a female mold, a male mold and a hardness enhancing portion. The male mold composed of a first material is used to imprint a female mold so as to produce a nano structural pattern on the female mold. The female mold is composed of a second material, and the hardness of the first material is higher than the hardness of the second material. The hardness enhancing portion that utilizes a nano-indentation apparatus above the female mold applies the nano-indentation technique to the female mold in order to enhance the surface hardness of the second material.

### BACKGROUND OF THE INVENTION

1. Field of the Invention

The present invention relates to an apparatus and a method for enhancing the hardness of a nanoimprint mold, and more particularly to an apparatus and a method for enhancing the hardness of a mold by a nano-indentation technique.

2. Description of the Related Art

As science and technology advance rapidly, people have increasingly higher demand on quality and convenience of life, and thus various electronic products are developed to meet customer needs, and a light, thin, low profile, compact and durable product design becomes a the tread of development of consumer products. Therefore, materials of higher hardness are used for the manufacture of these products, and a mold of higher hardness is required for enhancing the durability of the products. However, making a mold with a material of high hardness comes with a higher level of difficulty and incurs a higher cost. On the other hand, the durability is not good enough for its requirement, if materials with lower hardness and a lower cost are used for the manufacture.

A micro manufacturing process,such as photolithography plays a very important role in a semiconductor fabrication process. As related semiconductor fabrication process technologies and photolithographic equipments advance continuously, the photolithography encounters a bottleneck of the optical imaging technology since the wavelength of light exposure is reduced. To cope with the requirements of the micro manufacture and nano manufacture, the traditional photolithography has to reduce the wavelength of the light source to comply with the trend of light, thin, low profile and compact products, but the related light sources and peripheral systems are expensive and the related manufacturing processes are time consuming, and thus the traditional photolithography will encounter the difficulty for mass productions.

On the other hand, the nanoimprint technique is more convenient, simpler and easier, and such technique simply requires an imprinting mold and a transfer of a quick and repeating printing or patterning. In addition, the nanoimprint can lower costs, and the imprint technique can be applied for preparing patterns of a large area and thus greatly reduce production costs and increase productivity.

However, selecting the material for manufacturing the mold of a nanoimprint technique is still a problem. The material with high hardness used for making the mold incurs a high cost, but the material with low hardness cannot meet the requirements of the product.

Therefore, finding a way of lowering the cost of the mold and increasing the durability of the mold demands immediate attentions and feasible solutions.

In order to solve the problem with choosing materials for the mold, the inventor of the present invention based on years of experience in the related industry to conduct extensive researches and experiments, and finally proposed a feasible and effective solution by utilizing nanoindentation technology to enhance the nanoimprint mold.

### SUMMARY OF THE INVENTION

The primary objective of the present invention is to provide an apparatus and a method for enhancing hardness of a nanoimprint mold, and particularly to an apparatus and a method for enhancing hardness of a nanoimprint mold by a nano-indentation technique.

To achieve the foregoing objective, the present invention provides an apparatus for enhancing hardness of a nanoimprint mold, and the apparatus comprises a female mold, a male mold and a hardness enhancing portion. The male mold may be composed of a first material for imprinting a female mold so as to produce a nano structural pattern on the female mold. The female mold may be composed of a second material and the hardness of the first material is higher than the hardness of the second material. The hardness enhancing portion may be produced by placing a nano-indentation apparatus above the female mold and applying a nano-indentation technique to the female mold to enhance the surface hardness of the female mold.

Therefore, the apparatus and method for enhancing hardness of the nanoimprint mold in accordance with the present invention can use the male mold to imprint the female mold. After the nano structural pattern is produced, the nano-indentation technique can be applied to effectively enhance the surface hardness of the female mold.

To make it easier for our examiners to understand the technical characteristics and functions of the present invention, preferred embodiments accompanied with related drawings are used for the detailed description of the invention as follows.

### BRIEF DESCRIPTION OF THE DRAWINGS

The following is a detailed description of preferred embodiments of the invention with reference to the accompanying drawings.

In the figures:

FIG. 1 is a block diagram of an apparatus for enhancing the hardness of a nanoimprint mold in accordance with the present invention;

FIG. 2 is a schematic view of an apparatus for enhancing the hardness of a nanoimprint mold in accordance with a preferred embodiment of the present invention;

FIG. 3 is a schematic view of an apparatus for enhancing the hardness of a nanoimprint mold in accordance with further preferred embodiment of the present invention; and

FIG. 4 is a flow chart of a method for enhancing the hardness of a nanoimprint mold in accordance with the present invention.

### DETAILED DESCRIPTION OF THE PREFERRED EMBODIMENTS

In the following preferred embodiments of an apparatus for enhancing the hardness of a nanoimprint mold and a method thereof in accordance with the present invention, the same elements are represented by the same reference numerals for the illustration of the present invention.

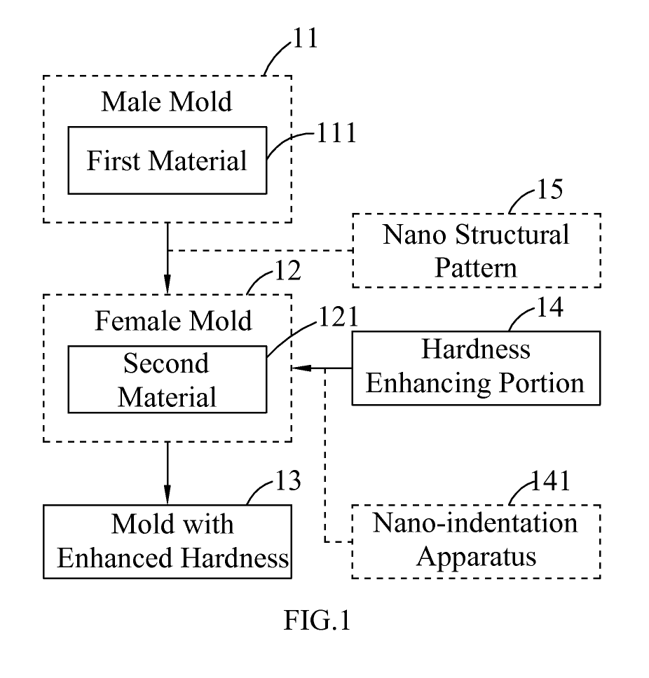

Please refer to FIG. 1 for a block diagram of an apparatus for enhancing the hardness of a nanoimprint mold in accordance with the present invention, the apparatus comprises a female mold 12, a male mold 11 and a hardness enhancing portion 14. The male mold 11 may be composed of a first material 111 for imprinting the female mold 12 to produce a nano structural pattern 15 on the female mold 12. The female mold 12 may be composed of a second material 121, wherein the hardness of the first material 111 may be higher than the hardness of the second material 121. In the hardness enhancing portion, a nano-indentation apparatus 141 may be used, and a nano-indentation technique may be applied to the female mold 12 to enhance the surface hardness of the female mold 12, so as to obtain a mold with enhanced hardness 13.

The male mold 11 may be produced by photolithography, E-beam lithography, X-ray lithography or Focus ion-beam lithography, and the male mold 11 may be a mold having a precision nano structural pattern.

The hardness enhancing portion may be made by a physical method or a chemical method. The physical method comprises placing a nano-indentation apparatus above the female mold, and the nano-indentation apparatus can be a diamond probe. The chemical method comprises an anodic treatment method. The second material comprises zirconium.

In addition, the apparatus for enhancing hardness of a nanoimprint mold in accordance with the present invention may further comprise a substrate, and the female mold imprints the nano structural pattern on the substrate.

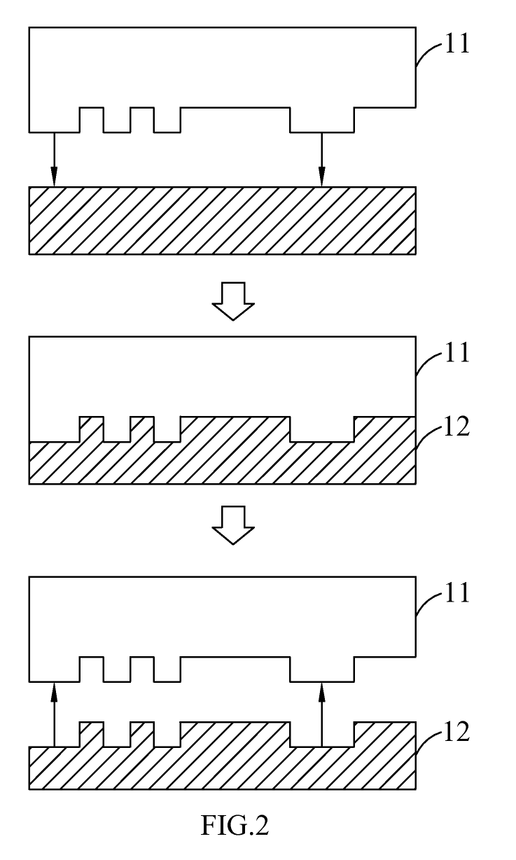

Please refer to FIG. 2 for a schematic view of an apparatus for enhancing the hardness of a nanoimprint mold in accordance with a preferred embodiment of the present invention, a method of manufacturing the female mold 12 is illustrated. Firstly, photolithography, E-beam lithography, X-ray lithography or Focus ion-beam lithography may be used for producing a male mold 11 having a precision nano structural pattern, and the male mold 11 may be made of a first material. Then, the male mold 11 imprints onto a female mold 12 made of a second material to form a nano structural pattern on the female mold 12. Finally, the male mold 11 is removed and then the manufacture of the female mold 12 is accomplished.

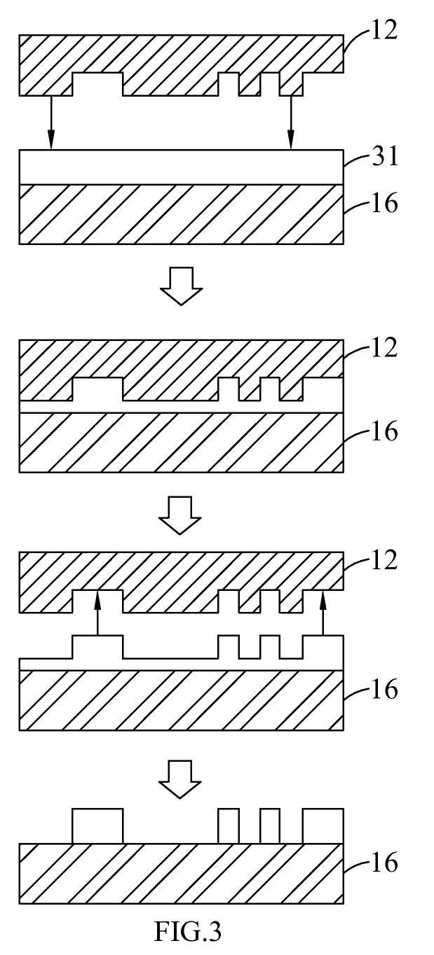

Please refer to FIG. 3 for a schematic view of an apparatus for enhancing the hardness of a nanoimprint mold in accordance with another preferred embodiment of the present invention, firstly the female mold 12 having a nano structural pattern imprints onto a photoresist layer 31 on a surface of a substrate 16, so that the nano structural pattern is transferred and printed onto the photoresist layer 31 of the substrate 16. Then, the female mold 12 is removed, and finally a Reactive Ion Etching (RIE) method is applied to remove any photoresist remained on the imprint area.

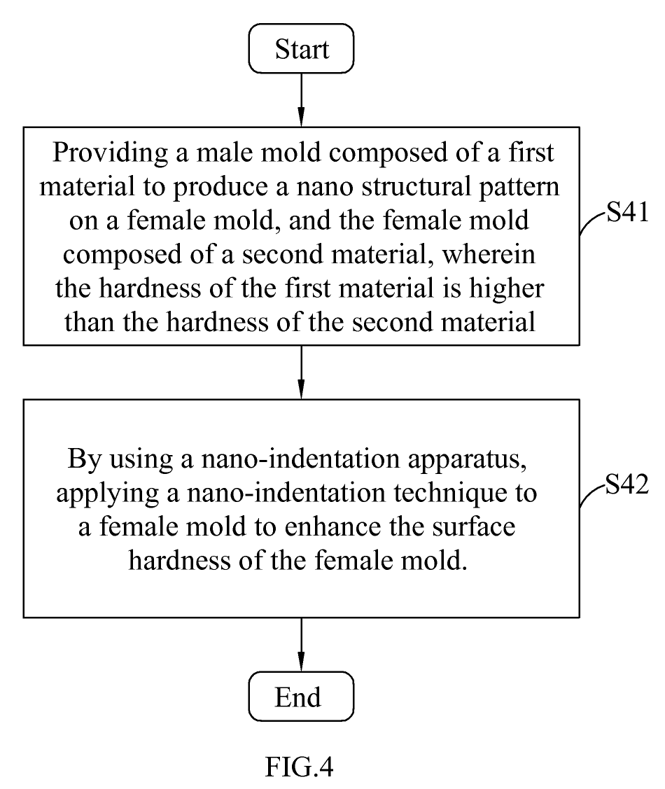

Please refer to FIG. 4 for a flow chart of a method for enhancing the hardness of a nanoimprint mold in accordance with the present invention, the method comprises the following steps. In step S41, a male mold composed of a first material is provided to produce a nano structural pattern on a female mold, and the female mold is composed of a second material, wherein the hardness of the first material is higher than the hardness of the second material; and in step S42, a hardness enhancing portion is used to enhance the surface hardness of the female mold.

The male mold may be produced by photolithography, E-beam lithography, X-ray lithography or Focus ion-beam lithography, and the male mold may be a mold having a precision nano structural pattern.

The hardness enhancing portion may be made by a physical method or a chemical method, and the physical method comprises placing a nano-indentation apparatus above the female mold, and the nano-indentation apparatus may be a diamond probe, and the chemical method comprises an anodic treatment method. The second material may be zirconium.

The method for enhancing the hardness of a nanoimprint mold in accordance with the present invention may further comprise a substrate, and the female mold may imprint the nano structural pattern on the substrate.

The present invention has been described with some preferred embodiments thereof and it is understood that many changes and modifications in the described embodiments can be carried out without departing from the scope and the spirit of the invention that is intended to be limited only by the appended claims.

What is claimed is:

1. An apparatus for enhancing hardness of a nanoimprint mold, comprising:
a female mold;
a male mold, composed of a first material, for imprinting the female mold and producing a nano structural pattern on the female mold, and the female mold composed of a second material, wherein the hardness of the first material is higher than the hardness of the second material; and
a hardness enhancing portion, disposed above the female mold for enhancing the surface hardness of the female mold.

2. The apparatus for enhancing hardness of a nanoimprint mold according to claim 1, wherein the male mold is produced by using photolithography, E-beam lithography, X-ray lithography or Focus ion-beam lithography.

3. The apparatus for enhancing hardness of a nanoimprint mold according to claim 1, wherein the male mold is a mold having a precision nano structural pattern.

4. The apparatus for enhancing hardness of a nanoimprint mold according to claim 1, wherein the hardness enhancing portion is produced by a physical method or a chemical method.

5. The apparatus for enhancing hardness of a nanoimprint mold according to claim 4, wherein the physical method comprises placing a nano-indentation apparatus above the female mold.

6. The apparatus for enhancing hardness of a nanoimprint mold according to claim 5, wherein the nano-indentation apparatus is a diamond probe.

7. The apparatus for enhancing hardness of a nanoimprint mold according to claim 4, wherein the chemical method comprises an anodic treatment method.

8. The apparatus for enhancing hardness of a nanoimprint mold according to claim 1, wherein the second material comprises zirconium.

9. The apparatus for enhancing hardness of a nanoimprint mold according to claim 1, further comprising a substrate, and the female mold imprinting the nano structural pattern on the substrate.

10. A method for enhancing hardness of a nanoimprint mold, comprising:
providing a male mold, composed of a first material, for imprinting a female mold and producing a nano structural pattern on the female mold, and the female mold composed of a second material, wherein the hardness of the first material is higher than the hardness of the second material, and
providing a hardness enhancing portion for enhancing the surface hardness of the female mold.

11. The method for enhancing hardness of a nanoimprint mold according to claim 10, wherein the male mold is produced by using photolithography, E-beam lithography, X-ray lithography or Focus ion-beam lithography.

12. The method for enhancing hardness of a nanoimprint mold according to claim 10, wherein the male mold is a mold having a precision nano structural pattern.

13. The method for enhancing hardness of a nanoimprint mold according to claim 10, wherein the hardness enhancing portion is produced by a physical method or a chemical method.

14. The method for enhancing hardness of a nanoimprint mold according to claim 13, wherein the physical method comprises placing a nano-indentation apparatus above the female mold.

15. The method for enhancing hardness of a nanoimprint mold according to claim 14, wherein the nano-indentation apparatus is a diamond probe.

16. The method for enhancing hardness of a nanoimprint mold according to claim 13, wherein the chemical method comprises an anodic treatment method.

17. The method for enhancing hardness of a nanoimprint mold according to claim 10, wherein the second material is zirconium.

18. The method for enhancing hardness of a nanoimprint mold according to claim 10, further comprising a substrate, and the female mold imprinting the nano structural pattern on the substrate.
